(19) United States
(12) Patent Application Publication
(10) Pub. No.: US 2006/0153654 A1
(43) Pub. Date: Jul. 13, 2006

(54) Processing machine with a workpiece exchanger

(75) Inventor: Fu-Long Chang, Taichung City (TW)

Correspondence Address: PILLSBURY WINTHROP SHAW PITTMAN, LLP, P.O. BOX 10500, MCLEAN, VA, 22102, US

(73) Assignee: SUEN CIN ENTERPRISE CO., LTD., Taichung City (TW)

(21) Appl. No.: 11/091,385

(22) Filed: Mar. 29, 2005

(30) Foreign Application Priority Data
Jan. 7, 2005 (TW) 94100478

(51) Int. Cl. B23C 1/00

(52) U.S. Cl. 409/235; 409/159

(57) ABSTRACT

A processing machine includes a slide seat, a spindle head seat and a workpiece exchanger. A threaded guide rod is journalled on a machine bed, and is rotatable to move the slide seat on the machine bed along a first direction. The spindle head seat is mounted movably on the slide seat, and is movable reciprocally along a second direction perpendicular to the first direction. The workpiece exchanger includes an exchanger body mounted rotatably on the machine bed at a position adjacent to the spindle head seat, and two worktables mounted respectively and movably on opposite side surfaces of the exchanger body. The workpiece body is rotatable about a third direction, which is perpendicular to the second direction, by 180 degrees to align a selected one of the worktables with the spindle head seat.

### CROSS-REFERENCE TO RELATED APPLICATION

This application claims priority of Taiwanese Application No. 094100478, filed on Jan. 7, 2005.

### BACKGROUND OF THE INVENTION

1. Field of the Invention

The invention relates to a processing machine, more particularly to a processing machine with a workpiece exchanger.

2. Description of the Related Art

Referring to FIG. 1, a first conventional processing machine 100 includes a T-shaped machine bed 1, a machine head 2 mounted movably on the machine bed 1 and movable horizontally along a first direction (X), a spindle head seat 3 mounted movably on the machine head 2 and movable vertically along a second direction (Y), a workpiece exchanger 4 mounted movably on the machine bed 1, and a worktable carrier 5 mounted movably between the machine head 2 and the workpiece exchanger 4 and movable horizontally along a third direction (Z). A first threaded guide rod 101 is journalled on the machine bed 1, and extends along the first direction (X). Two first guide rails 102 are disposed fixedly on the machine bed 1, and are parallel to the first threaded guide rod 101. A second threaded guide rod 103 is journalled on the machine bed 1, and extends along the third direction (Z). Two second guide rails 104 are disposed fixedly on the machine bed 1, and are parallel to the second threaded guide rod 103. The machine head 2 is mounted movably on the first guide rails 102, and is driven by the first threaded guide rod 101 to reciprocate along the first direction (X). A third threaded guide rod 201 is journalled on the machine head 2, and extends along the second direction (Y). The spindle head seat 3 is driven by the third threaded guide rod 201 to move vertically on the machine head 2 along the second direction (Y). The workpiece exchanger 4 is movable vertically along the second direction (Y), and is rotatable about a vertical axis. The worktable carrier 5 is driven by the second threaded guide rod 103 to reciprocate between the machine head 2 and the workpiece exchanger 4.

During operation, a first worktable 6 is loaded with a workpiece (not shown) to be processed, and is moved onto the workpiece exchanger 4. The worktable carrier 5, which carries a second worktable 6′ loaded with a processed workpiece (not shown) , is moved toward the workpiece exchanger 4. The workpiece exchanger 4 is descended to a lower limit position so as to allow for movement of the second worktable 6′ from the worktable carrier 5 onto the workpiece exchanger 4. Subsequently, the workpiece exchanger 4 is rotated by 180 degrees, and is ascended to an upper limit position so as to allow the first worktable 6 to be moved from the workpiece exchanger 4 onto the worktable carrier 5. For convenience in loading and unloading of the worktables 6, 6′, the workpiece exchanger 4 is formed with two diametrically opposed notches 401. However, due to the presence of the worktable carrier 5 between the spindle head seat 3 and the workpiece exchanger 4, the first conventional processing machine 100 suffers from the following disadvantages:
(1) The processing efficiency is reduced.
(2) It is difficult to process the workpieces 6, 6′ accurately.

FIG. 2 shows a second conventional processing machine 200 that includes a machine bed 7, and a machine head 8 mounted movably on the machine bed 7 and movable horizontally along a first direction (Z). A spindle head seat 9 is mounted movably on the machine head 8, and is movable vertically along a second direction (Y) perpendicular to the first direction (Z). A worktable carrier 901 is mounted movably on the machine bed 7 between the spindle head seat 9 and two workpiece loading seats 902, and is movable horizontally along a third direction (X) perpendicular to the first and second directions (Z, Y). The workpiece loading seats 902 are mounted movably on the machine bed 7, and are movable along the second direction (Y). Two threaded guide rods 903 are journalled respectively on two opposite sides of the worktable carrier 901, and extend along the first direction (Z). Two workpiece moving members 904 are driven by the threaded guide rods 903 to move along the first direction (Z). Each of the workpiece moving members 904 includes a telescopic push rod 905 that can be inserted into a slot 906′ in a workpiece 906 loaded on the corresponding workpiece loading seat 902. This allows the workpieces 906 to be moved from the workpiece loading seats 902 onto the worktable carrier 901. The second conventional processing machine 200 has the same disadvantages as the first conventional processing machine 100 (see FIG. 1).

### SUMMARY OF THE INVENTION

Therefore, the main object of this invention is to provide a processing machine that can overcome the aforesaid drawbacks of the prior art.

Accordingly, a processing machine of this invention includes a machine bed assembly, a slide seat, a spindle head seat and a workpiece exchanger.

The machine bed assembly includes a machine bed, a threaded guide rod journalled on the machine bed and extending along a first direction, and two guide rails disposed fixedly on the machine bed and parallel to the threaded guide rod.

The slide seat is mounted movably on the guide rails, and is driven by the threaded guide rod to reciprocate along the first direction.

The spindle head seat is mounted movably on the slide seat, and is movable reciprocally along a second direction perpendicular to the first direction.

The workpiece exchanger is mounted rotatably on the machine bed at a position adjacent to the spindle head seat, and includes an exchanger body having two opposite side surfaces, and two worktables mounted respectively and movably on the side surfaces. The exchanger body is rotatable about a third direction, which is perpendicular to the second direction, by 180 degrees so as to align a selected one of the worktables with the spindle head seat.

### BRIEF DESCRIPTION OF THE DRAWINGS

Other features and advantages of this invention will become apparent in the following detailed description of a preferred embodiment with reference to the accompanying drawings, of which:

FIG. 1 is a perspective view of a first conventional processing machine;

FIG. 2 is a perspective view of a second conventional processing machine;

FIG. 3 is a perspective view of the preferred embodiment of a processing machine according to this invention;

FIG. 4 is a top view of the preferred embodiment; and

FIG. 5 is a partly sectional, fragmentary side view of the preferred embodiment.

### DETAILED DESCRIPTION OF THE PREFERRED EMBODIMENT

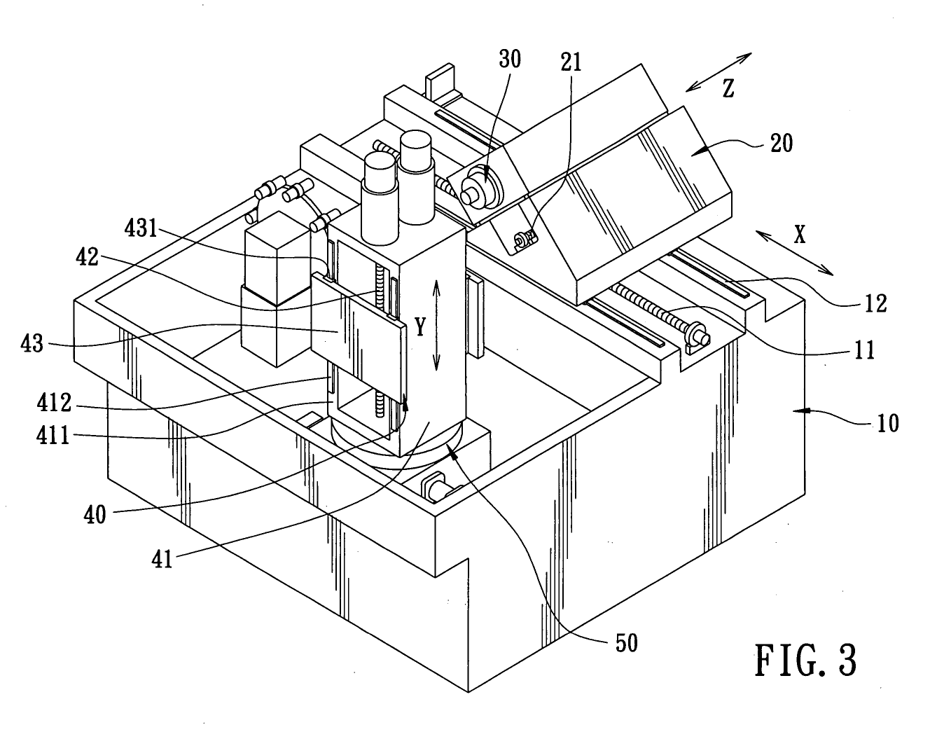

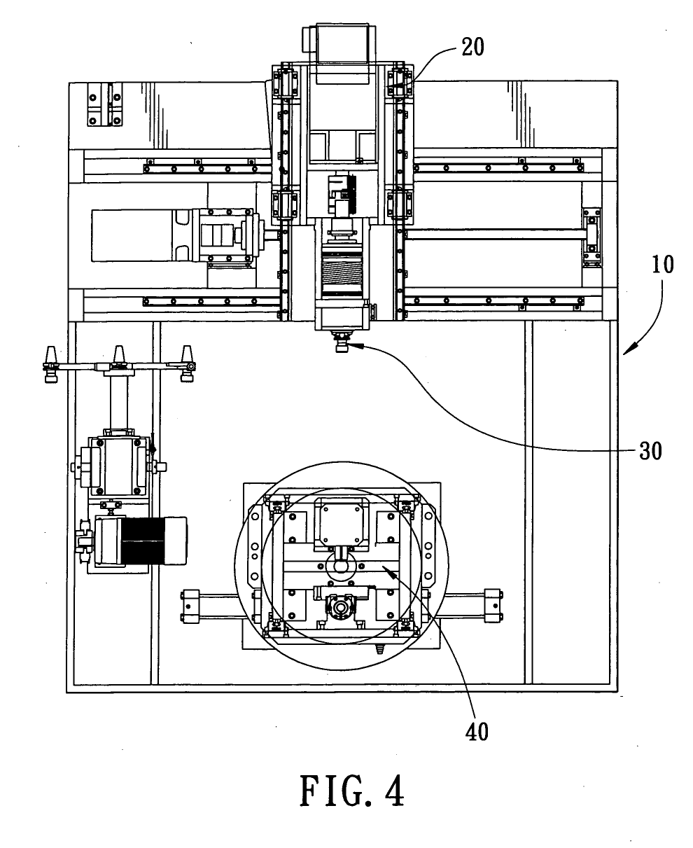

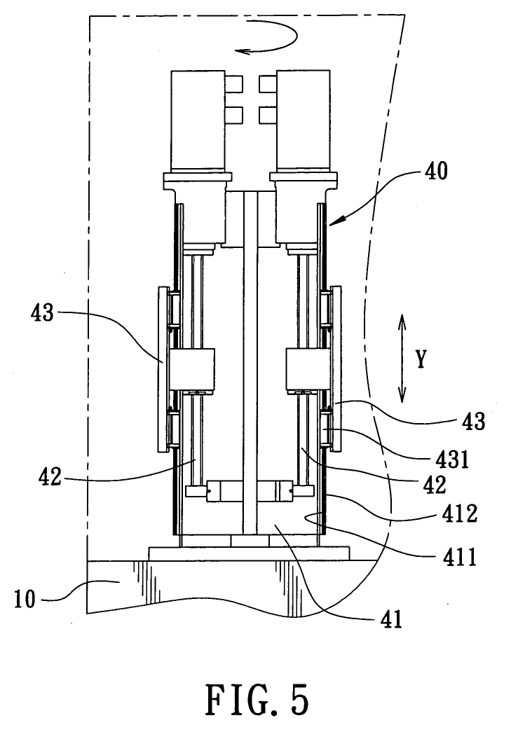

Referring to FIGS. 3, 4 and 5, the preferred embodiment of a processing machine according to this invention includes a machine bed assembly 10, a slide seat 20, a spindle head seat 30, a workpiece exchanger 40 and a rotating unit 50.

The machine bed assembly 10 includes a machine bed 13, a first threaded guide rod 11 journalled on the machine bed 13 and extending along a first direction (X), and two guide rails 12 disposed fixedly on the machine bed 13 and parallel to the first threaded guide rod 11.

The slide seat 20 is mounted movably on the guide rails 12, and is driven by the first threaded guide rod 11 to reciprocate along the first direction (X). The slide seat 20 includes a second threaded guide rod 21 journalled thereon and extending along a second direction (Z) perpendicular to the first direction (X).

The spindle head seat 30 is mounted movably on the slide seat 20, and is driven by the second threaded guide rod 21 to move reciprocally along the second direction (Z).

The workpiece exchanger 40 includes an exchanger body 41 mounted rotatably on the machine bed 13 and having two opposite side surfaces 411, and a pair of threaded driving rods 42 journalled within the exchanger body 41 and extending along a third direction (Y) perpendicular to the first and second directions (X, Z). In this embodiment, the exchanger body 41 extends along the third direction (Y). However, the exchanger body 41 may also extend along the first direction (X). Two worktables 43 are mounted respectively and movably on the side surfaces 411. Each of the side surfaces 411 of the exchanger body 41 is formed with two fixed parallel slide rails 412, on which the corresponding worktable 43 is disposed movably. The workpiece exchanger 40 is rotatable about the third direction (Y) by 180 degrees so as to align a selected one of the worktables 43 with the spindle head seat 30. The worktables 43 are driven respectively by the threaded driving rods 42 to move vertically along the third direction (Y). Each of the worktables 43 is equipped with a holder unit (not shown) for holding a workpiece (not shown). The holder units are well known in the art, and therefore are not further detailed.

The rotating unit 50 drives the workpiece exchanger 40 to rotate about a vertical axis by 180 degrees. Since the structure of the rotating unit 50 is well known in the art, and is not pertinent to the claimed invention, a further description thereof will be omitted herein.

In operation, the first threaded guide rod 11 drives the slide seat 20 and therefore, the spindle head seat 30 to move along the first direction (X). The second threaded guide rod 21 drives the spindle head seat 30 to move along the second direction (Z) so as to perform processing operations on the worktable 43 of the workpiece exchanger 40 that faces the spindle head seat 30. When processing of the workpiece is finished and the spindle head seat 30 is withdrawn, the workpiece exchanger 40 is rotated by 180 degrees so as to exchange the positions of the worktables 43 for subsequent processing operations.

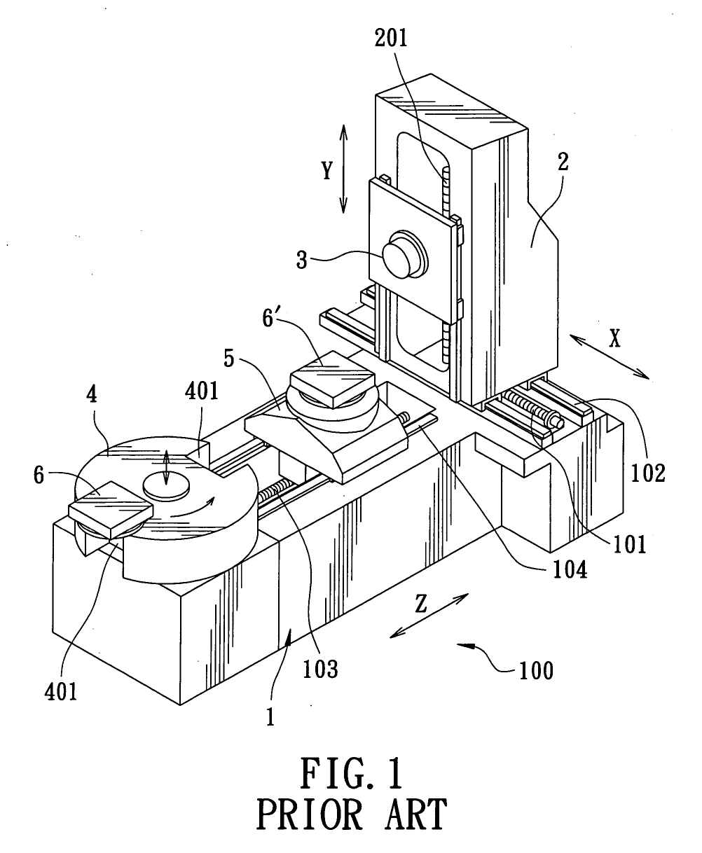

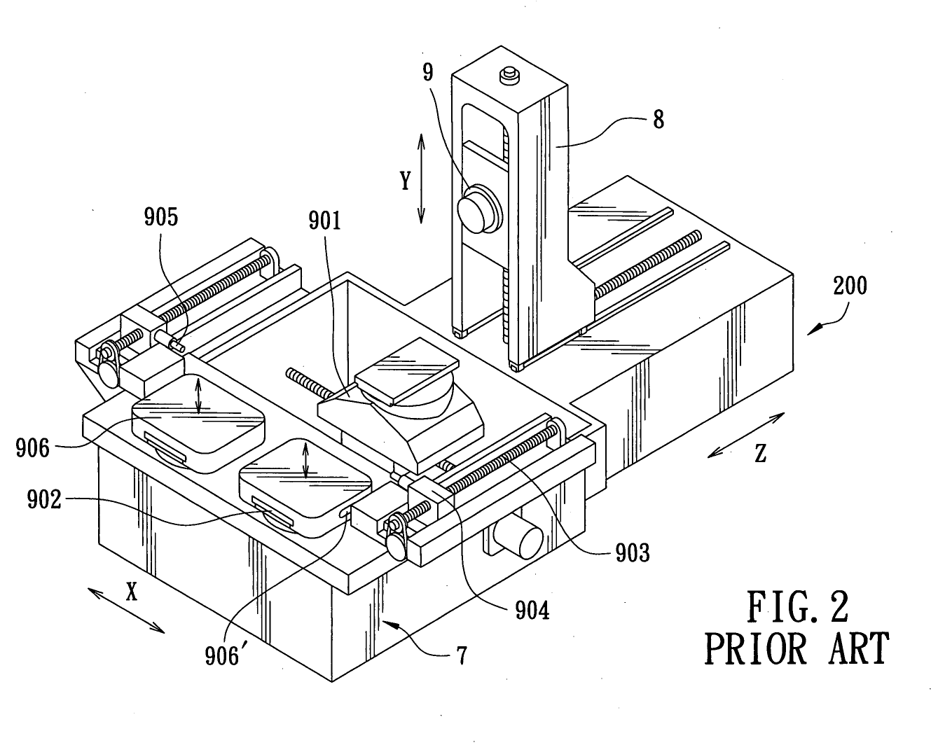

Because of the omission of the worktable carriers 5, 901 (see FIGS. 1 and 2) provided in the prior art, the processing efficiency of the processing machine of this invention is increased. Furthermore, workpieces can be processed accurately.

While this invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A processing machine comprising:
a machine bed assembly including a machine bed, a threaded guide rod journalled on said machine bed and extending along a first direction, and two guide rails disposed fixedly on said machine bed and parallel to said threaded guide rod;
a slide seat mounted movably on said guide rails, and driven by said threaded guide rod to reciprocate along the first direction;
a spindle head seat mounted movably on said slide seat and movable reciprocally along a second direction perpendicular to the first direction; and
a workpiece exchanger including
an exchanger body mounted rotatably on said machine bed at a position adjacent to said spindle head seat and having two opposite side surfaces, and
two worktables mounted respectively and movably on said side surfaces, said exchanger body being rotatable about a third direction, which is perpendicular to the second direction, by 180 degrees so as to align a selected one of said worktables with said spindle head seat.

2. The processing machine as claimed in claim 1, wherein said workpiece exchanger further includes a pair of threaded driving rods journalled within said exchanger body and extending along the third direction, each of said worktables being driven by a respective one of said threaded driving rods to move vertically along the third direction.

3. The processing machine as claimed in claim 2, wherein each of said side surfaces of said exchanger body is formed with two fixed parallel slide rails, on which a corresponding one of said worktables is disposed movably.
